(19) United States
(12) Patent Application Publication
(10) Pub. No.: US 2018/0068401 A1
(43) Pub. Date: Mar. 8, 2018

(54) Systems And Methods For Electronically Selling Property

(71) Applicant: Mohammd Talal Aboalshamat, Tampa, FL (US)

(72) Inventor: Mohammd Talal Aboalshamat, Tampa, FL (US)

(21) Appl. No.: 15/260,225

(22) Filed: Sep. 8, 2016

(51) Int. Cl. G06Q 50/16; G06Q 30/06; G06Q 30/00; G06F 3/0482; G06F 3/0481

(52) U.S. Cl. CPC G06Q 50/16; G06Q 30/06; G06F 3/04817; G06F 3/0482; G06Q 30/01

(57) ABSTRACT

A wireless device in bidirectional communication with a communication system having application software for displaying a property for sale. A user selects a property through the GUI, the selected property and data are displayed to a user through application software. The application software presents to a user the total list price of the selected property. A programmer divides the selected property into at least two portions, each having property rights of a predetermined monetary value that when combined equal the total listed value of the undivided property. Application software displays the selected property and the listed value of each divided portion to a user. A user selects at least one portion of the divided property. Application software displays to a user the combined listed value of the selected portion and then a user selects an icon of the application software to pay for the selected portion of divided property.

### BACKGROUND OF THE INVENTION

### 1. Field of the Invention

This invention relates, generally, to systems and methods for electronically selling property. More particularly, it relates to application software configured for a programmer to divide the property rights of a user selected property onto at least two portions and to display the listed price of the at least two portions of divided property to a user, whereby, the user can select to purchase at least one portion of the divided property.

### 2. Background Art

Many individuals want to purchase property such as real property, real estate, or personal property which can be costly and unaffordable for a vast majority of individuals. Often, these individuals cannot afford the costs associated with the purchase of 100% of the property rights of a property by themselves and end up either leasing or renting a property. It would be more desirable for an individual such as, a buyer to have the ability to become a joint owner of a divided portion of a property. There is a need for a network-enabled computer having an application software that displays to a buyer at least two portions of a divided property and the listed price of each of the at least two portions. A buyer can select an affordable portion of a divided property and purchase the selected portion of the divided property. This allows a buyer to spend within their budget while acquiring ownership of a corresponding percentage of a divided property.

Many individuals may not have the ability to travel to a location to preview a property. Additionally, many individuals may not have the monetary funds to purchase 100% of the property rights of a property. It is more desirable for an individual to be able to preview a property for sale on a network-enabled computer having application software. It is also more affordable for a programmer to divide the property rights into at least two separate portions each having a list price displayed on a graphical user interface (GUI) to a user.

However, in view of the prior art considered as a whole at the time the present invention was made, it was not obvious to those of ordinary skill in the pertinent art how the identified needs could be fulfilled.

### SUMMARY OF THE INVENTION

The long-standing but heretofore unfulfilled need for a wireless device in bidirectional communication with a communication system having application software configured to provide a graphical user interface (GUI) to a user for displaying an image of at least one property listed for sale from a database, whereby, the property having a list price predetermined by a programmer, a user selecting an image of at least one property through the GUI, the selected property and property data are displayed to a user through application software on the wireless device, the application software displaying to a user through a wireless device the total list price of the user selected property, a programmer dividing the total list price of the at least one property into at least two portions, whereby, the at least two portions each having a listed value predetermined by a programmer. It is within the scope of this invention for a user to include, but not be limited to, a buyer, a buyer's representative, a third party, or a combination of a buyer and the buyer's legal representative.

The combined listed value of each of the at least two portions of property is equal to the total list price of the undivided property. The at least two portions of divided property each have a percentage of property rights predetermined by a programmer, whereby, the combined percentage of property rights of each of the at least two portions is equal to 100% of property rights of the at least one property. The application software displays an image of each of the at least two portions of the divided property to a user on a wireless device. The divided portions of the selected property and the listed value of each of the divided portions of the selected property are displayed to a user. A user selects an image of at least one portion of the divided property through the GUI. The application software displays to a user the total combined listed value of the selected portion of divided property. A user selects an icon of the application software to proceed with payment for the selected portion of divided property, which, also includes improvements that overcome the limitations of prior art systems and methods for electronically selling property is now met by a new, useful, and non-obvious invention.

In a preferred embodiment, a method of electronically selling property has the steps of providing a wireless device in bidirectional communication with a communication system having an application software configured to provide a graphical user interface (GUI) to a user. A wireless device in bidirectional communication with a communication system includes, but is not limited to, an iPhone, an iPod, an iPad, a mobile device having an Apple's iOS operating system, a device having a Google Android operating system, a device having Microsoft's Windows Mobile operating system, a smartphone, a phone, a computer, or a tablet having internet or phone.

A communication system is any way of connecting a primary device to a secondary device including, but not limited to, a wireless communication network, a cellular network, a phone network, or the internet. It is within the scope of this invention for a network to include, but not be limited to, a wireless network, a wired network, or any combination of a wireless network and a wired network for transmitting and receiving a data signal.

Application software displays to a user an image of at least one property from a database. The database can retain at least one property listing. In another embodiment, the database can retain a plurality of property listings from a source including, but not limited to, manual upload, a real estate agency database, Ebay, Craigslist, a manufacturing company, a distribution company, a seller, a programmer, or another database.

The at least one property has a predetermined listed value determined by a programmer. The programmer includes, but is not limited to, a company, a seller, a relator, a sales agent, an individual, a buyer, or a real estate agent. It is within the scope of this invention for the at least one property to not need to come from a database, but the property can be individually uploaded to the application software by a programmer. It is within the scope of this invention for property to include, but not be limited to, land, a car, a boat, a building, a combination of land and buildings, real property, real estate, or personal property.

A user selects an image of a desired property from a database that is accessed through the application software. An image of the selected property is displayed to the user through the application software on the wireless device. The application software displays data of the selected property. It is within the scope of this invention for data to include, but not be limited to, identifying property information, total property listed value, undivided total list price of the selected property, property size, property location, a quantity, a photograph of the property, a video, an image, property type, representative information, GPS coordinate information, a physical address, type of dwelling, added features such as pool, clubhouse, gated community, golf course, guest parking, or waterfront view, or contact information for a realtor or homeowner associated with the property.

A programmer divides the selected property into at least two portions. The at least two portions of the divided selected property each have a listed value predetermined by a programmer. The combined listed value of each of the at least two portions of the divided selected property is equal to the undivided total list price of the undivided selected property. The application software displays the at least two portions of the divided selected property to a user on a wireless device. The at least two portions of the divided selected property each have a percentage of property rights predetermined by a programmer, whereby, the combined percentage of property rights of each of the at least two portions of the divided selected property is equal to 100% of property rights of the undivided selected property.

The application software displays to a user through the graphic user interface the listed value of each of the at least two portions of the divided selected property. The user selects at least one portion of the at least two portions through the GUI. It is within the scope of this invention for a user to select only one portion of the divided selected property, all of the portions of the divided selected property, or at least one portion of the divided selected property. It is also within the scope of this invention for at least one user or for a plurality of users to select at least one portion of a user selected divided property. It is within the scope of this invention for a user to enter into the graphical user interface the monetary value the user is willing to spend on a portion of a property. The user will then be presented through the graphic user interface the corresponding percentage of divided property for the user specified monetary value. The monetary value is the amount of money a user is willing to spend on at least one portion of property.

The application software displays to a user a total property cost of the at least one portion of divided property that was selected by the user. The user then selects an icon through the graphical user interface to make a payment for the at least one portion of a selected divided property.

In an alternate embodiment, a user selects a closing company. The application software presents the user with a contract. The user signs the contract and submits the signed contract to the closing company. It is within the scope of this invention for the user to execute a power of attorney with the user selected closing company. The user selected closing company signs the contract on behalf of the user. The closing company presents the seller with the signed contract through the application software. The seller then signs the signed contract and submits the signed contract to the closing company. The user then pays for their selected portions of divided property by transferring the total property cost to the closing company. The user then receives a warranty deed. Further, it is within the scope of this current invention for a buyer to choose the selected portion of property and then sign a power of attorney designating a legal representative to act on their behalf regarding matters between a third party and the closing company. The third party includes, but is not limited to, a holding company, an individual, or a corporate entity. The third party can collect payment from the buyer and then transfer the payment to the third parties escrow account. The third party can sign the contract and submits the signed contract to the closing company.

In another embodiment, a method of electronically selling property has the steps of providing a network-enabled computer. A network-enabled computer includes, but is not limited to, a computer device or a communications device. A communications device includes, but is not limited to, a server, a network appliance, a personal computer, a workstation, a mobile device, a phone, a handheld PC, a personal digital assistant, or an internet browser.

### BRIEF DESCRIPTION OF THE DRAWINGS

For a fuller understanding of the nature and objects of the invention, reference should be made to the following detailed description, taken in connection with the accompanying drawings, in which:

FIG. 1 is a flow chart illustrating the novel method of electronically selling property;

FIG. 2 is a perspective view of a network-enabled computer having a graphic user interface displaying at least one image of a listed property;

FIG. 3 is a flow chart illustrating the novel method of a GUI of a wireless device displaying a plurality of listed properties and their corresponding property data;

FIG. 4 is a perspective view of a GUI of a wireless device displaying a plurality of listed properties and their corresponding property data, whereby, a user selects an image of their desired property;

FIG. 5 is a perspective view a GUI of a wireless device displaying the user selected property and data corresponding with the selected property;

FIG. 6 is a perspective view a GUI of a wireless device displaying the user selected property and data corresponding with the selected property, whereby, a user selects the Purchase Information icon;

FIG. 7 is a perspective view a GUI of a wireless device displaying purchase information of a user selected property;

FIG. 8 is a perspective view a GUI of a wireless device displaying the selected divided portion of property, whereby, the percentage of property and the associated cost is displayed to a user;

FIG. 9 is a perspective view a GUI of a wireless device displaying an image of at least one closing company for a user to select;

FIG. 10 is a perspective view a GUI of a wireless device displaying the property contract to a user;

FIG. 11 is a perspective view a GUI of a wireless device displaying the signed property contract to a user;

FIG. 12 is a perspective view a GUI of a wireless device displaying a payment icon to a user; and,

FIG. 13 is a perspective view a GUI of a wireless device displaying the warranty deed to a user.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

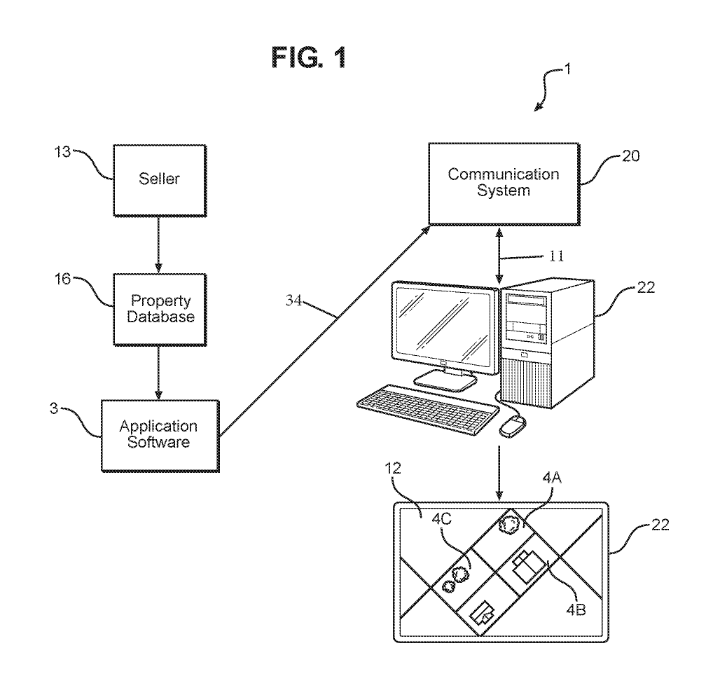

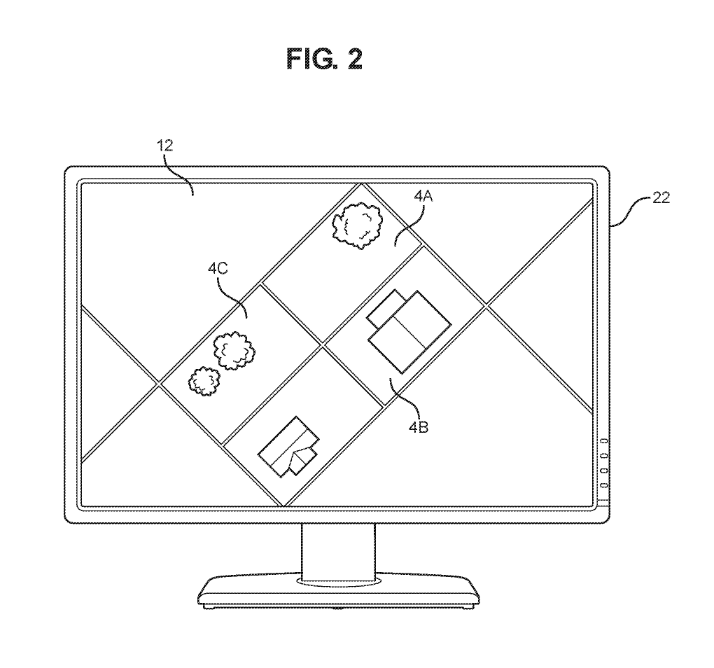

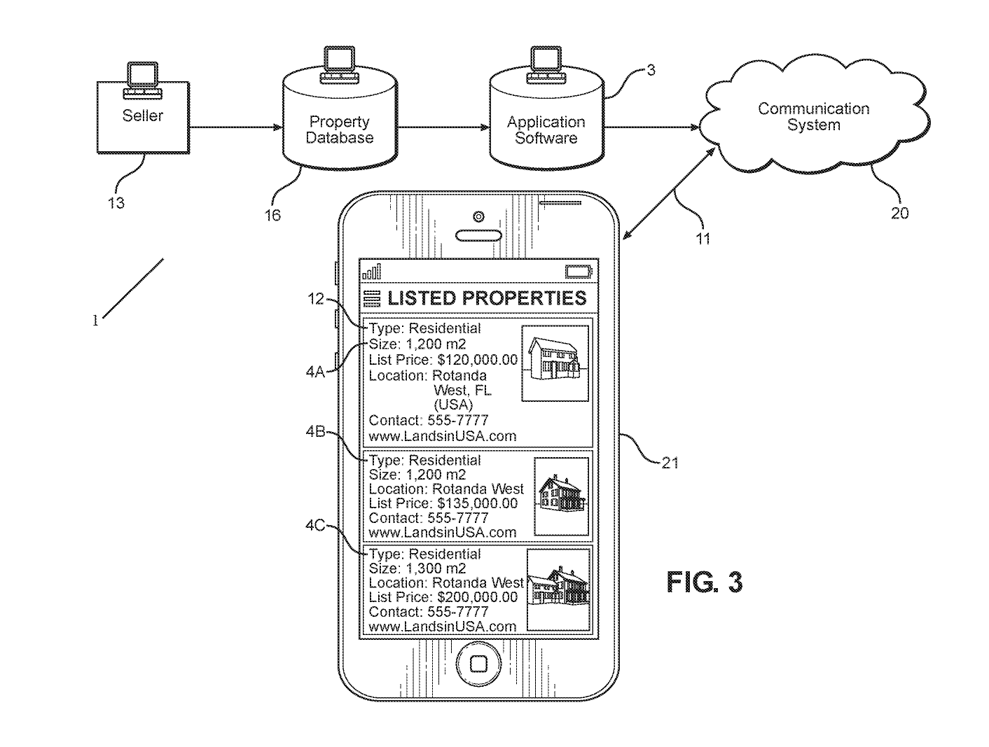

In a preferred embodiment, FIGS. 1 and 3 illustrate a method of electronically selling property 1 having seller 13 uploading or listing at least one property into property database 16. Property database 16 electrically communicates with application software 3. Application software 3 electrically communicates 34 with communication system 20. Communication system 20 is in bidirectional communication 11 with network-enabled computer 22 (FIG. 1). It is within the scope of this current invention for communication system 20 to be in bidirectional communication 11 with wireless device 21 (FIG. 3). FIGS. 1 and 2 show network-enabled computer 22 having graphical user interface 12 which displays to a user an image of listed properties 4A, 4B, and 4C. It is within the scope of this invention for GUI 12 to display at least one property to a user. A property includes, but is not limited to, real property, real estate, or personal property.

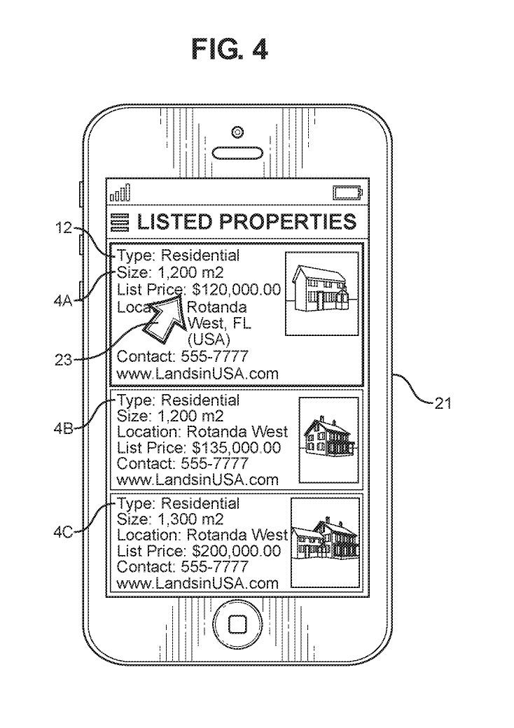

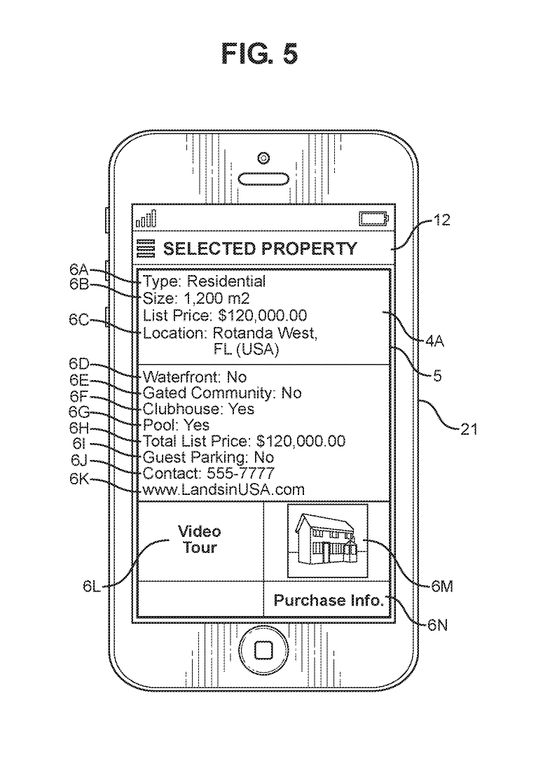

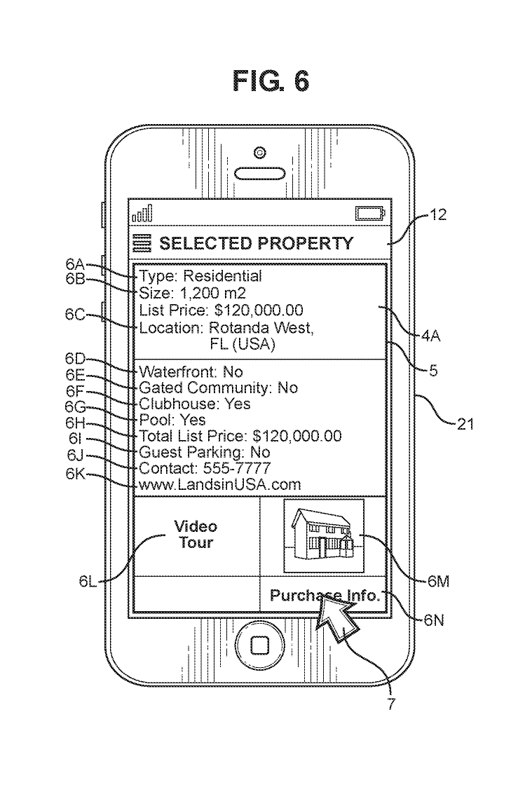

FIG. 3 shows the graphical user interface 12 displaying to a user (not shown) an image of at least one listed property 4A, 4B, and 4C. FIG. 4 depicts a user selecting a desired listed property with arrow 23. The user can interact with the graphical user interface with including, but not limited to, a mouse or a touch screen. The user has selected listed property 5 (FIG. 5) as being listed property 4A. FIG. 5 illustrates wireless device 21 having graphical user interface 12 displaying to a user an image of the user selected property 5. It is within the scope of this invention for at least one data 6A-6N to be displayed to a user. For example, 6A is the property type, 6B is the property size, 6C is the property location, 6D is the waterfront feature, 6E is the gated community feature, 6F is the clubhouse feature, 6G is the pool feature, 6H is the total list price, 6J is the representative contact phone number, 6K is a website address, 6L is a video tour, 6M is an image of the selected listed property, and 6N is an icon for more purchase information. FIG. 6 depicts a user selecting an icon for more purchase information with arrow 7.

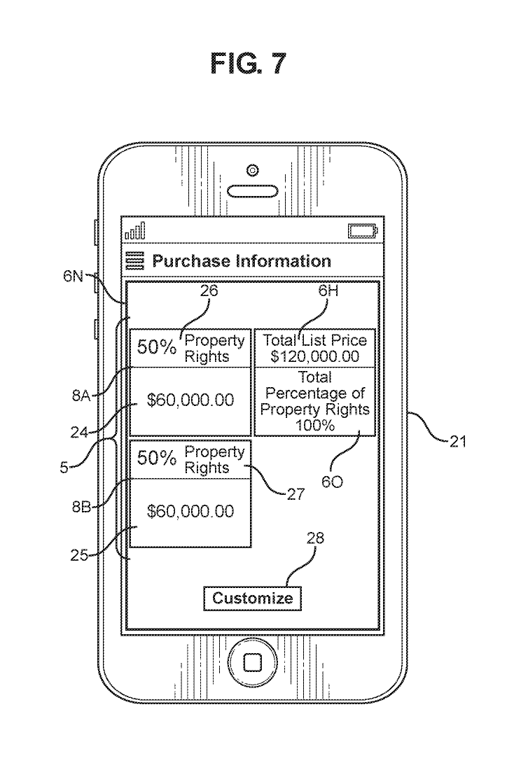

FIG. 7 shows graphical user interface 12 displaying an image of purchase information data of selected listed property 5. Selected listed property 5 is divided into portions 8A and 8B. For example, divided portion 8A has divided listed value 24 being $60,000.00. Divided portion 8B has divided listed value 25 being $60,000.00. The selected listed property can be divided into at least two portions. It is within the scope of this invention for the divided property values to be displayed to a user on a grid. Divided property portion 8A has divided percentage of property rights 26 being 50%. Divided property portion 8B has divided percentage of property rights 27 being 50%. 6H illustrates an image of the total list price 6H of $120,000.00 for the combined divided listed values of 24 and 25. 60 illustrates the total percentage of property rights being 100% for the combined value of divided property rights of 26 and 27.

Each grid portion 8A and 8B can have a total combined value of total value 6H of selected property 5.The total value 6H of selected listed property 5 is determined by a programmer (not shown). A programmer includes, but is not limited to, a third party, a seller, or a buyer. The programmer also determines how selected listed property 5 will be divided, whereby, each divided portion of selected property 5 will have a monetary value displayed in at least two grid portions. For example (not shown), buyer selected property 5 is property 4A. Property 4A has a total value of $4,000.00. The programmer has divided property 4A into four portions 8A, 8B, 8C, and 8D. The programmer can determine and assign each of the divided property portions a value. The value of portion 8A is $1,000.00 for 25% of property 4A, 8B is $1,000.00 for 25% of property 4A, 8C is $1,000.00 for 25% of property 4A, and 8D is $1,000.00 for 25% of property 4A. It is within the scope of this invention for the divided portions of the selected listed property to be displayed on a grid, a chart, a graph, as text, or as an image.

In another embodiment, the programmer can be a buyer. The buyer can determine the amount of money they want to spend. For instance, as shown in FIG. 7, a buyer can select the customize icon 28 to enter in the monetary value that the buyer is willing to invest on a portion of property. If a buyer wants to only spend $500.00 on a portion of property 4A that has a total value being $4,000.00, the value of the portion would be $500.00 for 12.5% of property 4A. A buyer could enter the percentage of property 26 or the divided property cost 24 into the field of graphical user interface 12. The parameters predetermined by the programmer would correspond to a first buyer inputted field with a second programmer inputted field. For example, if a buyer wants to only spend $500.00 on a portion of property 4A that has a total value being $4,000.00, the buyer would input into the first buyer inputted field the value of $500.00. The second programmer inputted field would have the predetermined value of 12.5% of property 4A.

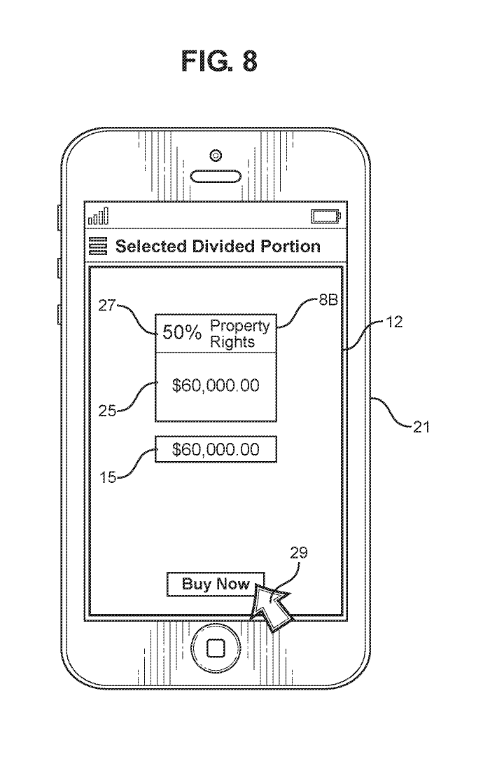

FIG. 8 depicts wireless device 21 having graphical user interface 12 displaying to a buyer (not shown) the selected divided portion 27 of 8B having divided property rights 27 being 50% and divided listed value of $60,000.00. The buyers total cost 15 is $60,000.00. It is within the scope of this invention for a buyer to select to buy a plurality of portions of divided property. The buyer selects Buy Now icon or Purchase icon 29 to proceed with paying for divided portion 8B of property 4A.

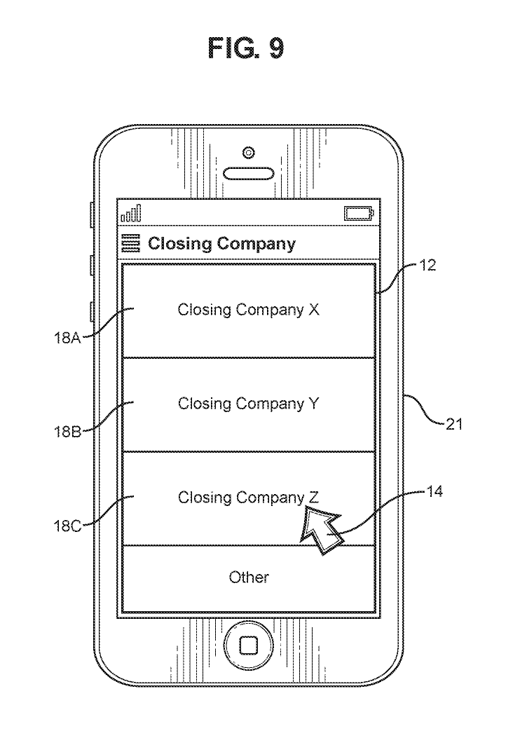

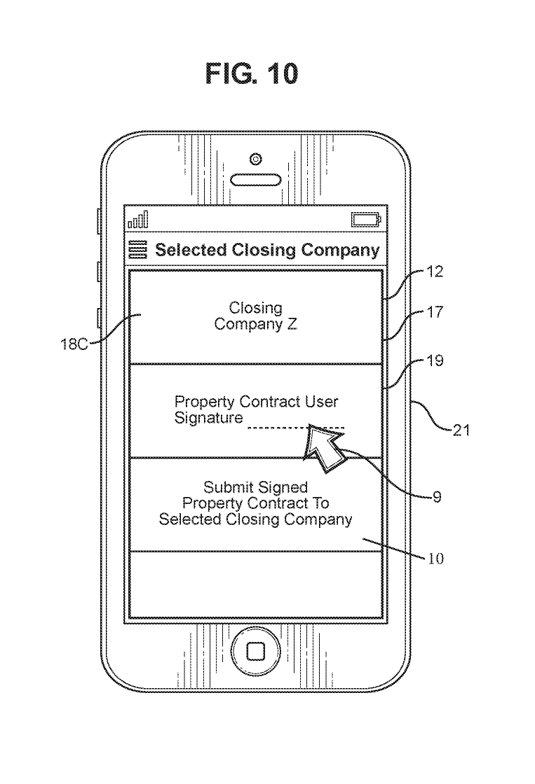

FIGS. 9 and 10 depict wireless device 21 having graphical user interface 12 displaying to a buyer (not shown) at least one closing company 18A-18C (FIG. 9). The buyer (not shown) selects 14 (FIG. 9) selected closing company 17 being 18C. FIG. 10 shows buyer being presented with contract 19. FIG. 10 illustrates the buyer signing 9 contract 19. A legal representative including, but not limited to, the selected closing company 18C can sign contract 19 on behalf of the buyer. The signed contract is submitted 10 (FIG. 10) to selected closing company 18C by the buyer if contract 19 is signed directly by the buyer or signed contract 19 can be submitted 10 to the seller if the selected closing company 18C is the legal representative of the buyer.

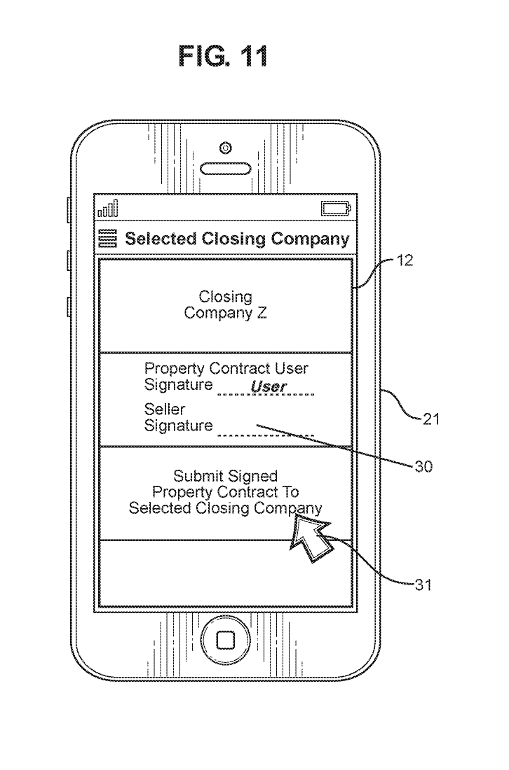

FIG. 11 depicts wireless device 21 having graphical user interface 12 displaying to a seller (not shown) the user signed contract. The seller signs 30 contract 19 and the seller submits 31 the contract back to the closing company 18C.

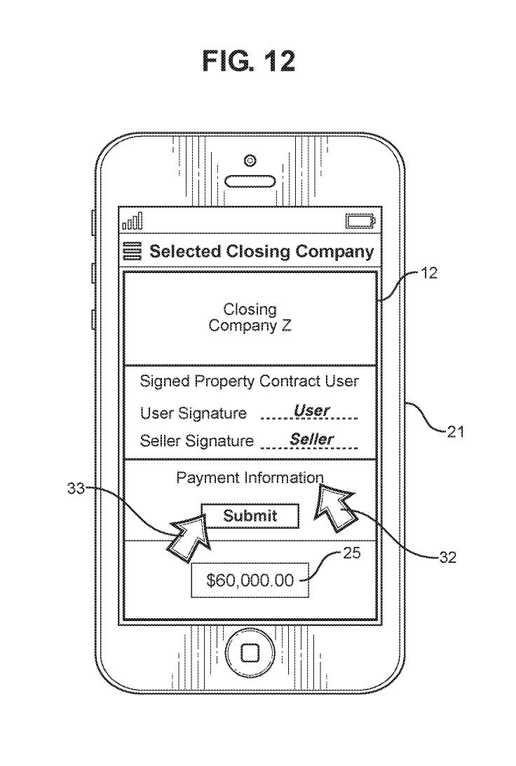

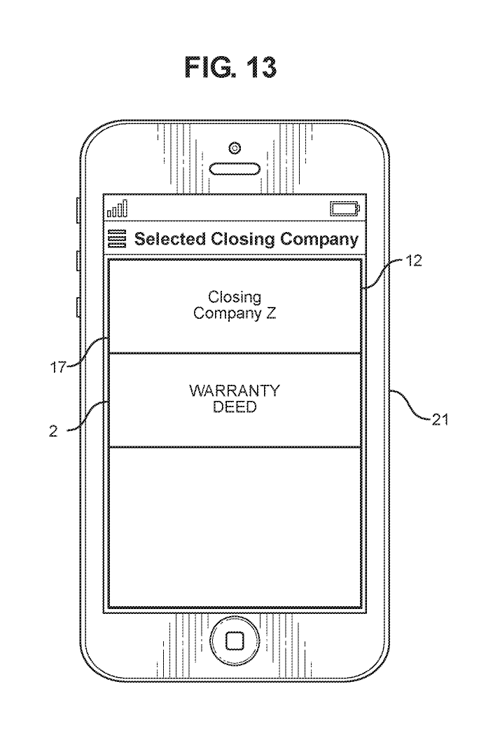

FIG. 12 depicts wireless device 21 having graphical user interface 12 displaying to a buyer (not shown) that the seller has signed the contract. The buyer can enter payment information 32 into graphical user interface 12 and transfer 33 payment to the closing company. FIG. 13 illustrates wireless device 21 having graphical user interface 12 displaying to a buyer (not shown) an image of selected closing company 17 presenting the buyer with an image of warranty deed 2.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

The invention claimed is:

1. A method of electronically selling property, comprising the steps of:
providing a wireless device in bidirectional communication with a communication system having an application software providing a graphical user interface on said wireless device;
said application software displaying to a user through said graphic user interface an image of at least one listed property from a database, whereby, said at least one listed property has a predetermined total list price determined by a programmer, said at least one listed property has a predetermined total percentage of property rights, said at least one listed property has at least two predetermined divided portions each having a predetermined divided value, whereby, said programmer dividing said at least one listed property into a first divided portion having a first divided listed value and a second divided portion having a second divided listed value, whereby, the sum of said first divided listed value and said second divided listed value is equal to said total list price of said at least one listed property;
said first divided portion having a first divided percentage of property rights predetermined by said programmer, said second divided portion having a second divided percentage of property rights predetermined by said programmer, whereby, the sum of said first divided percentage of property rights and said second divided percentage of property rights is equal to said total percentage of property rights of said at least one property;
said user selecting a selected listed property from said at least one listed property through said graphic user interface;
said application software displaying to said user through said graphic user interface data of said selected listed property;
said user selecting purchase information from said data of said selected listed property through said graphic user interface, whereby, said application software displaying to said user through said graphic user interface said purchase information comprising, an image of a total list price of said selected listed property, an image of a total percentage of property rights of said selected listed property, an image of a first divided portion of said selected listed property comprising an image of a first divided listed value of said selected listed property and an image of a first divided percentage of property rights of said selected listed property, an image of a second divided portion of said selected listed property comprising an image of a second divided listed value of said selected listed property and an image of a second divided percentage of property rights of said selected listed property;
said user selecting an image of at least one divided portion of said selected listed property through said graphical user interface;
said application software displaying to a user through said graphic user interface an image of a total property cost of said at least one divided portion of said selected listed property; and,
said user selecting an icon through said graphical user interface to purchase said at least one divided portion of said selected listed property.

2. The method of electronically selling property of claim 1, further comprising the steps of: said application software displaying to a user through said graphic user interface an image of at least one closing company, said user selecting an image of a selected closing company, whereby, said user executing a power of attorney to said selected closing company.

3. The method of electronically selling property of claim 2, further comprising the steps of: said application software presenting to said user through said graphic user interface a contract, whereby, said selected closing company signing said contract.

4. The method of electronically selling property of claim 3, further comprising the steps of: said selected closing company presenting a seller of said selected listed property with said signed contract, whereby, said seller signing said signed contract, said seller submitting said signed contract to said selected closing company.

5. The method of electronically selling property of claim 4, further comprising the steps of: said user transferring a payment of said total property cost of said at least one divided portion of said selected listed property to said selected closing company.

6. The method of electronically selling property of claim 5, further comprising the steps of: said application software presenting to said user through said graphic user interface a warranty deed from said selected closing company.

7. A method of electronically selling property, comprising the steps of:
providing a network-enabled computer in bidirectional communication with a communication system having an application software providing a graphical user interface on said network-enabled computer;
said application software displaying to a user through said graphic user interface an image of at least one listed property from a database, whereby, said at least one listed property has a predetermined total list price determined by a programmer, said at least one listed property has a predetermined total percentage of property rights, said at least one listed property has at least two predetermined divided portions each having a predetermined divided value, whereby, said programmer dividing said at least one listed property into a first divided portion having a first divided listed value and a second divided portion having a second divided listed value, whereby, the sum of said first divided listed value and said second divided listed value is equal to said total list price of said at least one listed property;
said first divided portion having a first divided percentage of property rights predetermined by said programmer, said second divided portion having a second divided percentage of property rights predetermined by said programmer, whereby, the sum of said first divided percentage of property rights and said second divided percentage of property rights is equal to said total percentage of property rights of said at least one property;
said user selecting a selected listed property from said at least one listed property through said graphic user interface;
said application software displaying to said user through said graphic user interface data of said selected listed property;
said user selecting purchase information from said data of said selected listed property through said graphic user interface, whereby, said application software displaying to said user through said graphic user interface said purchase information comprising, an image of a total list price of said selected listed property, an image of a total percentage of property rights of said selected listed property, an image of a first divided portion of said selected listed property comprising an image of a first divided listed value of said selected listed property and an image of a first divided percentage of property rights of said selected listed property, an image of a second divided portion of said selected listed property comprising an image of a second divided listed value of said selected listed property and an image of a second divided percentage of property rights of said selected listed property;
said user selecting an image of at least one divided portion of said selected listed property through said graphical user interface;
said application software displaying to a user through said graphic user interface an image of a total property cost of said at least one divided portion of said selected listed property; and,
said user selecting an icon through said graphical user interface to purchase said at least one divided portion of said selected listed property.

8. The method of electronically selling property of claim 7, further comprising the steps of: said application software displaying to a user through said graphic user interface an image of at least one closing company, said user selecting an image of a selected closing company.

9. The method of electronically selling property of claim 8, further comprising the steps of: said application software presenting to said user through said graphic user interface a contract, whereby, said user signing said contract, said user submitting a signed contract to said selected closing company.

10. The method of electronically selling property of claim 9, further comprising the steps of: said selected closing company presenting a seller of said selected listed property with said signed contract, whereby, said seller signing said signed contract, said seller submitting said signed contract to said selected closing company.

11. The method of electronically selling property of claim 10, further comprising the steps of: said user transferring said total property cost of said at least one divided portion of said selected listed property to said selected closing company.

12. The method of electronically selling property of claim 11, further comprising the steps of: said application software presenting to said user through said graphic user interface a warranty deed from said selected closing company.
